(19) United States
(12) Patent Application Publication
(10) Pub. No.: US 2025/0084891 A1
(43) Pub. Date: Mar. 13, 2025

(54) CONNECTING DOME, IN PARTICULAR SCREW DOME, AND FASTENING ASSEMBLY

(71) Applicant: Witte Automotive GmbH, Velbert (DE)

(72) Inventors: Ismail ULU, Wuppertal (DE); Jan Christian BENTE, Sprockhövel (DE); Harry PURWIN, Ratingen (DE); Klaus SPICKENHEIER, Iserlohn (DE)

(21) Appl. No.: 18/826,256

(22) Filed: Sep. 6, 2024

(30) Foreign Application Priority Data
Sep. 8, 2023 (DE) 10 2023 208 711.1

(51) Int. Cl. F16B 37/12; H01M 50/262

(52) U.S. Cl. CPC F16B 37/122; H01M 50/262

(57) ABSTRACT

A connecting dome for fastening at least one component and/or for connecting two components is provided. The connecting dome is designed as an assembly unit and may have a dome element with a longitudinal axis and a bore in which a tolerance compensation unit is arranged. A fastening assembly having the connecting dome is also provided.

### FIELD

The invention relates to a connecting dome, in particular a screw dome or threaded dome, for fastening at least one, in particular encapsulated, component and/or for connecting components. Furthermore, the invention relates to a fastening assembly having a number of such connecting domes.

Connecting domes, in particular screw domes, are generally known from the prior art, e.g., from battery housings, in which connecting domes, encapsulated by a potting material of a component, serve to connect housing walls and housing covers to the component.

### BACKGROUND

The object of the present invention is to provide an improved connection dome which in particular enables a low-stress or stress-free connection to the component or components. Furthermore, a fastening assembly with at least one such improved connecting dome is to be provided.

The first-mentioned object is achieved according to the invention with a connecting dome, in particular a fixing dome, e.g., a screw dome or threaded dome, for fastening at least one, in particular encapsulated, component and/or for connecting two components, with the features of claim 1. The second-mentioned object is achieved according to the invention by a fasting arrangement having the features of claim 12.

### SUMMARY

The connecting dome according to the invention has a longitudinal axis and a bore in which a tolerance compensation unit is arranged. In particular, the connecting dome is designed as an assembly unit. The connecting dome comprises an, in particular cylindrical, dome element with the longitudinal axis and the bore in which the tolerance compensation unit is arranged. The bore may, for example, be designed as a through-bore or a blind hole in the dome element. The dome element with through-bore is designed as a hollow-cylindrical dome element. The dome element with blind hole is designed as a partially hollow-cylindrical dome element.

The connecting dome may have a circumferential surface which in sections is provided with at least one profile, in particular recesses and/or webs. For example, the profile may be a rib profile, a form-fitting profile, a force-fitting profile and/or a material-locking profile, in particular a profiled notch, a thread profile, a friction profile, or the like. In particular, the connecting dome may be provided in sections with radially inwardly directed recesses which are introduced into the connecting dome from the outside in a row vertically one above the other. The recesses may be separated from each other by webs.

For example, the dome element may have a fixing profile, in particular a thread profile or screw profile, in sections on an inner circumferential surface, in particular a wall of the bore. The fixing profile serves, in particular, for engaging a connecting element, in particular a screw element or the like. The thread profile or screw profile may have individual threads. Alternatively, the thread profile or screw profile may be designed as a metric thread, a steep thread, a trapezoidal thread, or the like. Alternatively, instead of the fixing profile, a nut element may be inserted into the bore and connected in a rotationally fixed manner, in particular clipped in, overmolded, or pressed in.

Additionally or alternatively, the dome element may in sections be provided with a profile on an outer circumferential surface, which forms a material, form-fitting, and/or force-fitting connection when encapsulated with a potting material.

By means of such a profile (also called profiling) on the outer circumferential surface of the connecting dome, the latter may be designed to form a form-fitting and force-fitting, in particular frictional, connection when encapsulated with a potting material, so that a force can be transmitted when the connecting dome is connected to another component by means of a connecting element, in particular a screw. For example, the outer circumferential surface may be provided with one or more ribs so that a form-fitting connection to the potting compound or the potting material is formed or exists.

In a possible further development, the tolerance compensation unit comprises at least one retaining element, one compensating element, and one base element. The tolerance compensation unit may be retained in the bore in a form-fitting and/or force-fitting manner by means of the retaining element. In particular, the base element is firmly, in particular rotationally fixedly, connected to the dome element. The compensating element is arranged to be axially movable in the base element in order to compensate for axial play.

In addition, the tolerance compensation unit may be arranged in the bore in an initial state such that it is flush with the dome element. The initial state is understood to mean, in particular, a delivery state or a not-yet-connected state. Furthermore, the tolerance compensation unit is arranged in the bore such that at least one part, in particular the compensating element, of the tolerance compensation unit in a compensation state protrudes at least in sections beyond the bore, in particular axially.

The fastening arrangement according to the invention for fastening a component or for connecting components to be connected to each other comprises a plurality of the previously described connecting domes. The connecting domes are cast or overmolded with a potting compound and firmly connected to the component or one of the components, in particular, in a material-locking and rotationally fixed manner, wherein the tolerance compensation unit, when fastened to the component or when the components are connected, compensates for any play with respect to the component, in particular, any play between the dome element and the component to be fastened, or between the components.

The internal tolerance compensation unit, which is arranged, in particular, in the bore, ensures that, when the connecting dome is attached to a component or when the connecting dome is connected to at least one of the components, an axial play, in particular axial tolerances, can be compensated for by means of the tolerance compensation unit. This makes it possible to easily fasten or connect the cast component without stress or at least with little stress by means of the connecting dome with an internal tolerance compensation unit.

### DESCRIPTION OF THE FIGURES

Exemplary embodiments of the invention are explained in greater detail with reference to the drawings. In the figures:

FIG. 1 is a sectional view of a connecting dome with a tolerance compensation unit,

FIG. 2 is a schematic sectional view of the connecting dome according to FIG. 1 cast into a partially encapsulated component,

FIG. 3 is a schematic sectional view of the potted connection dome before connecting the partially encapsulated component to another component via the tolerance compensation unit,

FIG. 4 is a schematic sectional view of the two components connected by means of the connecting dome, with compensation for axial tolerances by means of the integrated tolerance compensation unit,

FIG. 5 is a schematic exploded view of the connecting dome and the tolerance compensation unit,

FIG. 6 schematically shows a perspectival view of the connecting dome,

FIG. 7 schematically shows another perspectival view of the connecting dome,

FIG. 8 is a schematic sectional view of the connecting dome with a closure element for the bore,

FIG. 9 is a schematic sectional view of an assembly of two components with several connecting domes,

FIG. 10 is a schematic plan view of the assembly as shown in FIG. 9,

FIG. 11 is a schematic plan view of an alternative assembly of two components which are being connected or are connected to each other by means of a connecting dome cast in one of the components,

FIG. 12 is a perspectival view of an alternative connecting dome with a tolerance compensation unit,

FIG. 13 is a sectional view of another alternative connecting dome with a tolerance compensation unit,

FIG. 14 is a sectional view of another alternative connecting dome with a tolerance compensation unit,

FIG. 15 is a sectional view of another alternative connecting dome with a tolerance compensation unit in an initial state,

FIG. 16 is a sectional view of the connecting dome after axial tolerance compensation by means of a drive element, and

FIG. 17 is a perspectival view of the connecting dome with the drive element inserted.

### DETAILED DESCRIPTION

Parts corresponding to one another are provided with the same reference signs in all the drawings.

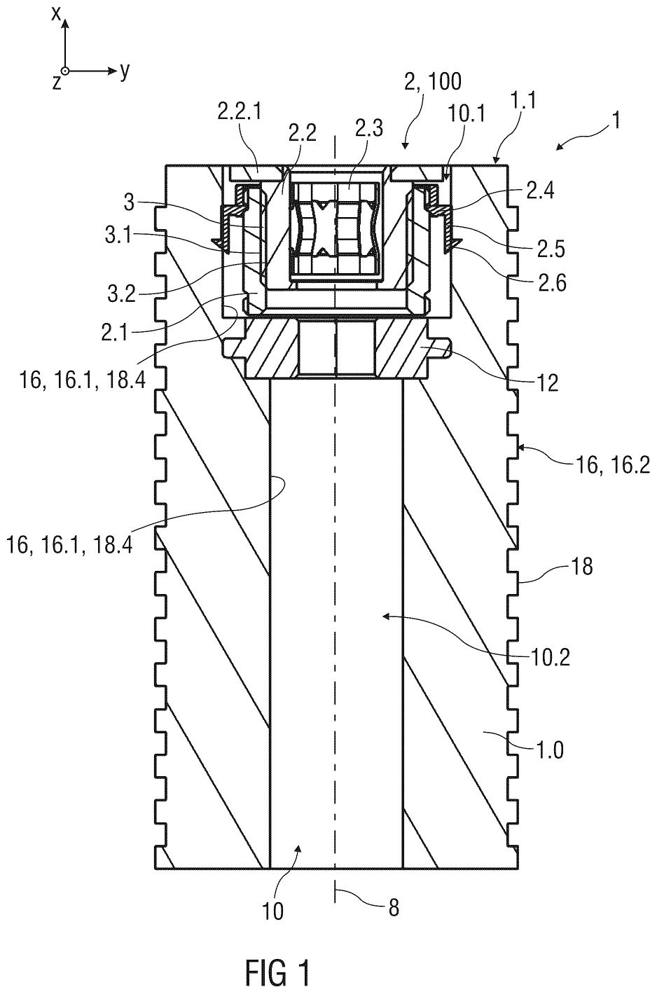

FIG. 1 shows a sectional view of a connecting dome 1 with a tolerance compensation unit 2.

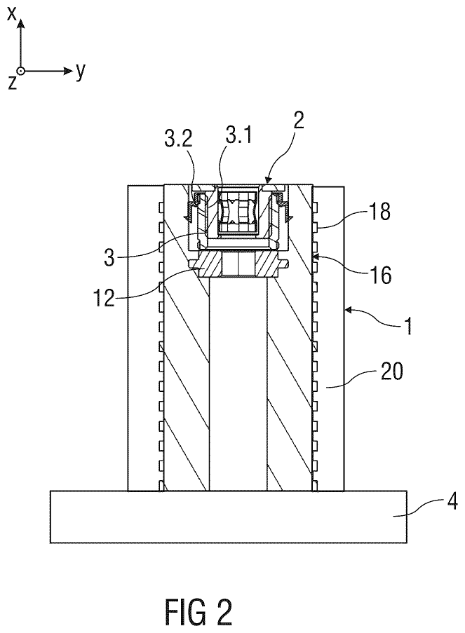

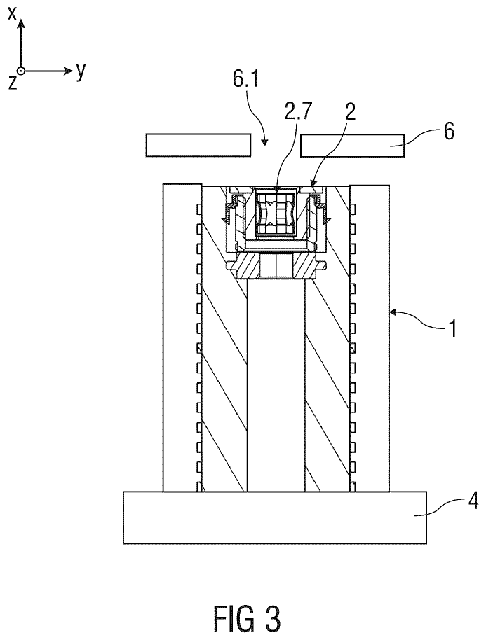

The connecting dome 1 is designed, for example, as a fixing dome, in particular a screw dome or threaded dome. The connecting dome 1 serves to fasten at least one component 4 (shown in FIG. 2), in particular one which is partially encapsulated, and/or to connect two components 4 and 6 (shown in FIGS. 3 and 4, 9).

The connecting dome 1 has an integrated tolerance compensation unit 2 and, together with this, forms an, in particular one-piece, assembly unit.

The connecting dome 1 comprises a dome element 1.0, in particular a cylindrical dome element 1.0.

The connecting dome 1 has a longitudinal axis 8 and a bore 10, in particular a through-bore. The connecting dome 1 comprises the cylindrical dome element 1.0 with the longitudinal axis 8 and the bore 10 in which the tolerance compensation unit 2 is arranged. The bore 10 may, for example, be formed as a through-bore or a blind hole in the dome element 1.0. The dome element 1.0 with through-bore is designed as a hollow-cylindrical dome element 1.0. The dome element 1.0 with blind hole is designed as a partially hollow-cylindrical dome element 1.0.

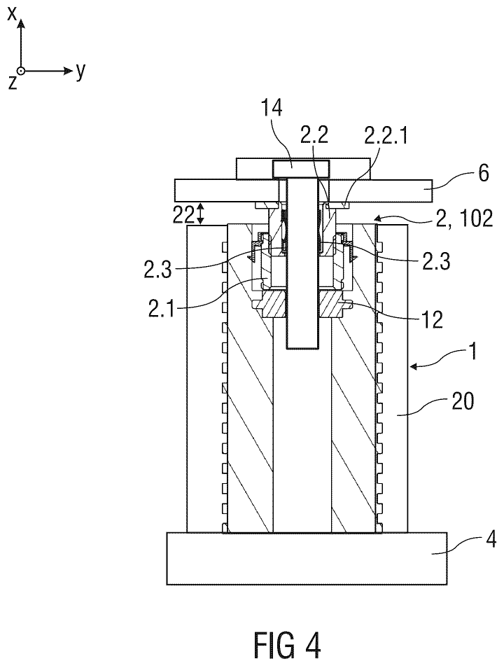

The tolerance compensation unit 2 is arranged in the bore 10. In particular, the bore 10 has a receiving section 10.1 and a connecting section 10.2. The receiving section 10.1 has a larger diameter than the connecting section 10.2. The receiving section 10.1 serves to receive and fix the tolerance compensation unit 2. The connecting section 10.2 may be provided with a nut element 12 for a screw element 14 (shown in FIG. 4).

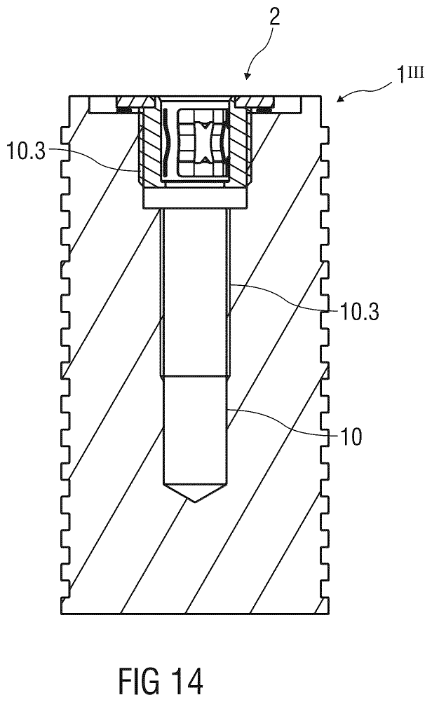

Alternatively, the receiving section 10.1 and/or the connecting section 10.2 may be provided with an internal profiling for the tolerance compensation unit 2 and/or an internal profile 18.4 (also called fixing profile), in particular with an internal thread 10.3 (shown in FIG. 14) for the screw element 14.

The internal profile 18.4 may, in particular, be a form-fitting profile and/or a force-fitting profile, in particular a profiled notch or a threaded profile or screw profile. The internal profile 18.4 of the bore 10 may be designed in sections for the rotationally fixed fastening of the tolerance compensation unit 2, in particular a base element 2.1 and/or the nut element 12, in the bore 10. The nut element 12 may, for example, be clipped, pressed, injection-molded, or the like into the bore 10. The tolerance compensation unit 2, in particular its base element 2.1, may, for example, be clipped, pressed, injection-molded, or the like into the bore 10, in particular in the receiving section 10.1.

The tolerance compensation unit 2 is arranged in the receiving section 10.1 such that it is flush with an end face 1.1 of the connecting dome 1. In particular, a contact flange 2.2.1 of a compensating element 2.2 of the tolerance compensation unit 2 is arranged flush with the end face 1.1 of the connecting dome 1. The compensating element 2.2 is arranged in a starting position 100 relative to the base element 2.1. The carrier element 2.2 may be formed in one piece or in multiple pieces. In the embodiment shown, the contact flange 2.2.1 is formed separately, and the compensating element 2.2 is designed as a hollow-cylindrical element.

The compensating element 2.2 and the base element 2.1 are arranged coaxially to each other and inside each other. The compensating element 2.2 and the base element 2.1 can be connected to each other in a form-fitting and/or force-fitting manner. For example, the compensating element 2.2 and the base element 2.1 can be connected or are connected to each other in an axially movable manner by means of a threaded connection 3. For this purpose, the compensating element 2.2 and the base element 2.1 have corresponding threads 3.1, 3.2.

The connecting dome 1 is, in particular, made of a plastic material. The nut element 12 may be formed from a metal or from a hard plastic material.

The connecting dome 1 is designed to be hollow-cylindrical or partially hollow-cylindrical. The connecting dome 1 has an outer circumferential surface 16.2, which is provided in sections with at least one profile 18 (also called external profile). For example, the profile 18 may be a rough surface, a rib profile, a form-fitting profile, a force-fitting profile, and/or a material-locking profile, in particular a profiled notch, a thread profile, a friction profile, or the like.

The internal tolerance compensation unit 2 arranged in the bore 10 ensures that axial tolerances 22 (also called axial play or axial tolerances 22, shown in FIG. 4) can be compensated for when connecting the connecting dome 1 to the components 4, 6.

The tolerance compensation unit 2 can be used for fastening to the component 6 or for connecting the two components 4, 6 to each other across a tolerance-affected joint gap while compensating for the axial play and the axial tolerances 22 by means of the screw element 14 (as shown in FIGS. 3 and 4). The tolerance compensation unit 2 comprises a base element 2.1, a compensating element 2.2, a entrainment element 2.3, and a retainer 2.4. The second entrainment element 2.3 is arranged in the compensating element 2.2 in a rotationally fixed manner. The entrainment element 2.3 is designed, in particular, as an entrainment spring.

The retainer 2.4 serves to form-fittingly and/or force-fittingly fix the tolerance compensation unit 2 on or in the connecting dome 1, in particular, in the receiving section 10.1 of the connecting dome 1. The retainer 2.4 is, in particular, designed to be flexible so that the tolerance compensation unit 2 can align itself relative to the bore 10 and the nut element 12.

The retainer 2.4 has, for example, a number of flexible holding arms 2.5 with locking hooks 2.6 projecting radially outwards at their free ends. The retainer 2.4 is designed, for example, as a retaining ring.

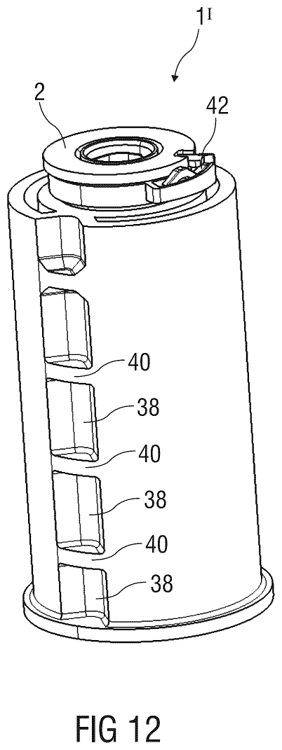

The retainer 2.4 may additionally be designed as a transport lock 42 (shown in FIG. 12) or may include such a transport lock. This ensures that the compensating element 2.2 is retained securely in the connecting dome 1. Thus, the compensating element 2.2 cannot rotate out of the base element 2.1 during transport.

In addition, the retainer 2.4 comprises a rotation protection so that the tolerance compensation unit 2 is retained and fixed in or on the connecting dome 1 in a non-rotatable or rotationally fixed manner. For this purpose, the retainer 2.4 comprises the form-fitting and/or force-fitting fixation, e.g., the locking hooks 2.6, which engage form-fittingly and/or force-fittingly into an inner wall of the bore 10.

FIG. 2 shows a schematic sectional view of the connecting dome 1 according to FIG. 1 potted in a potting material 20 of the partially encapsulated component 4.

The connecting dome 1 with internal tolerance compensation unit 2 and internal nut element 12 is arranged on a surface of the component 4, e.g., a bottom surface of a housing, in particular a battery housing, and is surrounded on the outside by the potting material 20.

By means of the profile 18 on the outer circumferential surface 16.2 (shown in FIG. 1) of the connecting dome 1, said connecting dome is configured to form a form-fitting and force-fitting, in particular frictional, connection with the potting material 20 when being encapsulated with the potting material 20, so that, when the connecting dome 1 is connected to the further component 6 (shown in FIGS. 3 and 4) by means of the screw element 14 (shown in FIG. 4), a force can be transmitted. The compensating element 2.2 can move axially relative to the base element 2.1, which is arranged in the connection dome 1 in a rotationally fixed manner, and thus relative to the connection dome 1, to compensate for axial tolerances 22 (shown in FIG. 4) between the connection dome 1 and/or the potting material 20 and the component 6.

FIG. 3 shows a schematic sectional view of the potted connection dome 1 before a connection of the partially encapsulated component 4 to the other component 6 via the tolerance compensation unit 2. The further component 6 has a flange 6.1. The further component 6 is positioned relative to the connecting dome 1 and aligned such that a through-opening 2.7 of the tolerance compensation unit 2 and the component opening 6.1 lie one above the other.

FIG. 4 shows a schematic sectional view of the two components 4, 6 connected by means of the connecting dome 1 and the screw element 14, with axial tolerances 22 compensated for by means of the integrated tolerance compensation unit 2.

For this purpose, the connecting dome 1 with the internal tolerance compensation unit 2 is arranged between the components 4 and 6 to be connected. The connecting dome 1 is cast onto the component 4, which is partially surrounded by the potting material 20, and is integrally connected to the component 4 by means of the potting material 20.

The screw element 14 for screwing the components 4 and 6, e.g., a screw or a threaded bolt, is screwed through the provided component opening 6.1 (shown in FIG. 3) of the component 6 and through the tolerance compensation unit 2 via the entrainment element 2.3 into the nut element 12 (shown in FIG. 1).

When screwing the screw element 14, the compensating element 2.2 is rotated relative to the base element 2.1 via the entrainment element 2.3 connected between the screw element 14 and the compensating element 2.2 and is thereby moved axially relative to the base element 2.1 from the starting position 100 (shown in FIG. 1), in particular screwed out.

In other words, the compensating element 2.2 is rotated out of the base element 2.1 and the connecting dome 1 until it reaches a compensating position 102 in which the compensating element 2.2, in particular the contact flange 2.2.1, rests against the component 6 and thus bridges the axial tolerances 22 in the form of a joint gap.

By integrating the tolerance compensation unit 2 into the connecting dome 1, a stress-free or at least low-stress connection of the encapsulated component 4 to the component 6 is made possible in a simple manner.

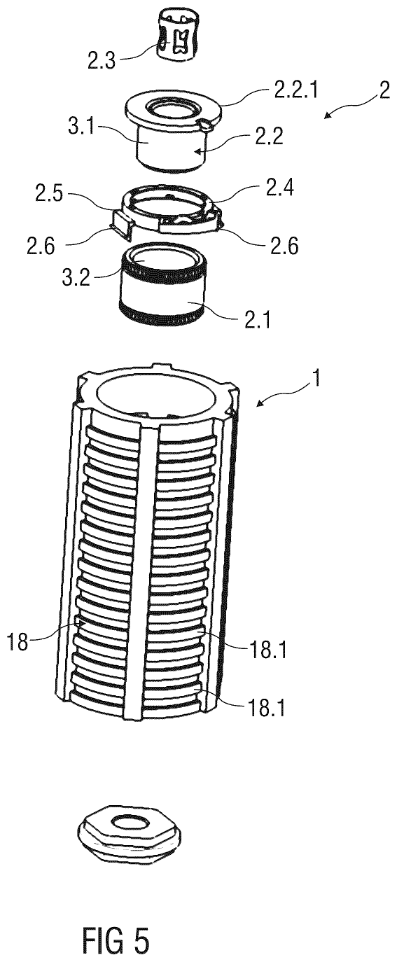

FIG. 5 shows a schematic exploded view of the connecting dome 1 and the tolerance compensation unit 2.

The connecting dome 1 comprises as profile 18, in particular an external profile, for example, a number of circumferential ribs 18.1 and/or a number of longitudinal ribs 18.2.

The tolerance compensation unit 2 comprises the hollow-cylindrical base element 2.1 with the thread 3.2 designed as an internal thread 10.3 (shown in FIG. 14), the compensating element 2.2 with the thread 3.1 designed as an external thread and in one piece with the contact flange 2.2.1, the entrainment element 2.3, designed as a entrainment spring, and the retainer 2.4 with two opposing holding arms 2.5 and locking hooks 2.6.

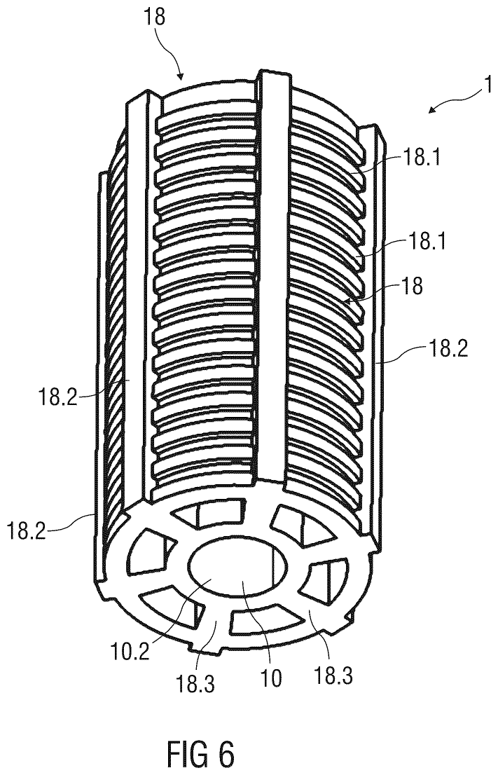

FIG. 6 shows a schematic perspectival view of the connecting dome 1 from below. Depending upon the design of the connecting dome 1, it may be ribbed on the inside, in addition to the external profile 18. In particular, a number of radial ribs 18.3 may be provided on an outer wall of the bore 10, in particular, in regions in the connecting section 10.2—for example, at a bore inlet. The radial ribs 18.3 extend between an outer wall of the bore 10 and an outer wall of the connecting dome 1. For this purpose, the connecting dome 1 is designed, for example, as a hollow-cylindrical, double-walled element. By means of the radial ribs 18.3, sufficient strength and rigidity are achieved, while simultaneously reducing material and weight.

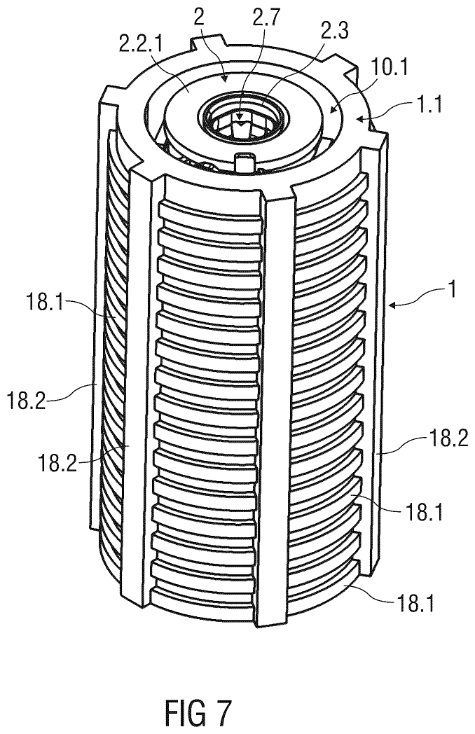

FIG. 7 shows schematically in another perspectival view from above the connecting dome 1 with inserted tolerance compensation device 2.

The tolerance compensation device 2 is arranged and fixed centrally in the receiving section 10.1 by means of the retainer 2.4 (shown in FIG. 1). The contact flange 2.2.1 is arranged flush with the end surface 1.1 of the connecting dome 1. The entrainment element 2.3 is arranged approximately flush with the contact flange 2.2.1 and in the through-opening 2.7.

The longitudinal ribs 18.2 are arranged so as to be symmetrically distributed. The longitudinal ribs 18.2 extend over the entire axial length of the connecting dome 1. A plurality of circumferential ribs 18.1 extend circumferentially between each two longitudinal ribs 18.2. In addition to the form-fitting connection and/or force-fitting connection with the potting material 20 (shown in FIG. 2), the longitudinal ribs 18.2 serve as a rotation protection to prevent the connecting dome 1 from rotating during the screwing of the components 4 and 6 with the screw element 14 (shown in FIG. 4).

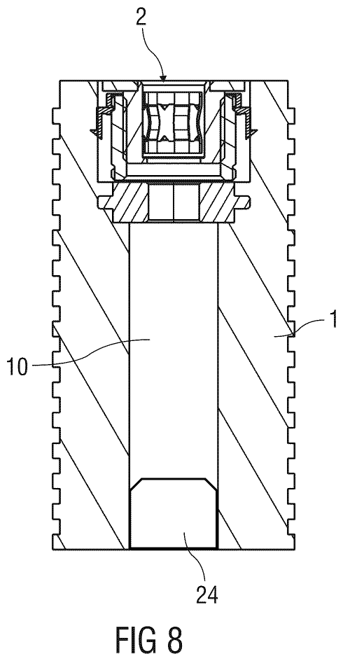

FIG. 8 shows a schematic sectional view of the connecting dome 1 with a closure element 24 for the bore 10. The closure element 24 is inserted into the bore 10 at the end, opposite the tolerance compensation unit 2, of the connecting dome 1.

As a result, a closed surface is formed in the bottom area of the connecting dome 1, so that no potting material 20 gets into the bore 10 when pouring in or casting onto the component 4.

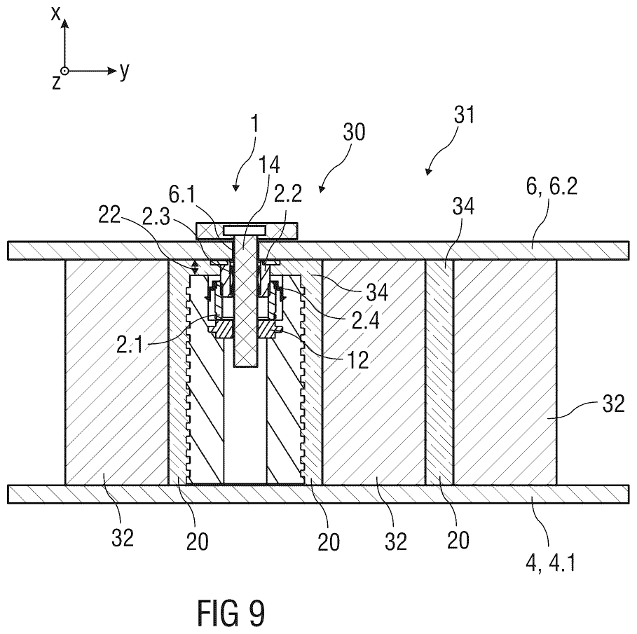

FIG. 9 shows a schematic plan view of an assembly 30, e.g., a housing, in particular a battery housing, with a fastening assembly 31 for fastening one of the components 4 or 6, or for connecting these components 4, 6 to each other by means of a number of connecting domes 1. The assembly 30 comprises as component 4, for example, a base 4.1 and as component 6, for example, a cover 6.2.

In the assembly 30, for example, a plurality of components 32, in particular battery cells or battery modules, are arranged. To connect the base 4.1 and the cover 6.2, at least one connecting dome 1 with integrated tolerance compensation unit 2 is arranged between several of the components 32.

First, the components 32 and the at least one connecting dome 1 are arranged on the base 4.1. Spaces 34 formed between the components 32 and the at least one connecting dome 1 are filled with the potting material 20. The potting material 20 is poured into these spaces 34 and cured.

The cover 6.2 is then positioned and aligned in relation to the connecting dome 1 as component 6. To connect the cover 6.2 as component 6 and the base 4.1 as component 4 and/or the components 32 arranged between them, the screw element 14 is screwed through the provided component opening 6.1 of the component 6 and through the tolerance compensation unit 2 via the entrainment element 2.3 into the nut element 12.

When screwing the screw element 14, the compensating element 2.2 is rotated relative to the base element 2.1 via the entrainment element 2.3 connected between the screw element 14 and the compensating element 2.2, and is thereby moved axially relative to the base element 2.1 from the starting position 100 (shown in FIG. 1), in particular screwed out, in order to compensate for axial tolerances 22 between the components 4, 6, in particular between the connecting dome 1 and the component 6.

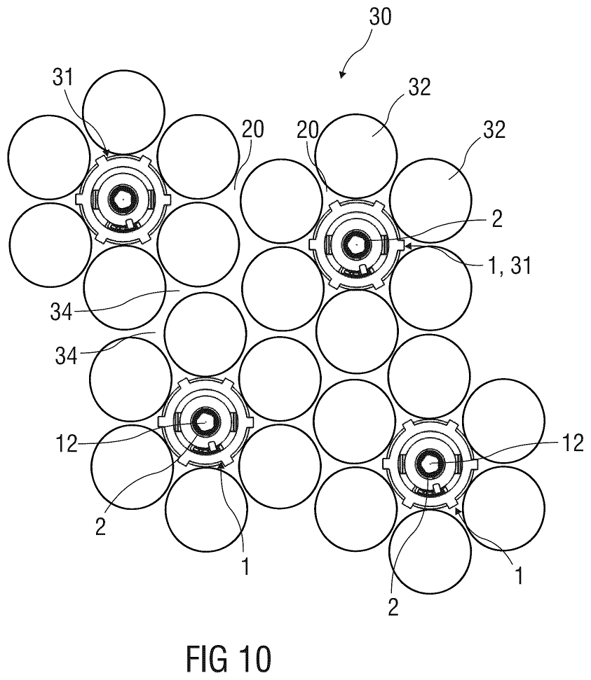

FIG. 10 shows a schematic plan view of the assembly 30 without cover 6.2 and with several connecting domes 1 as a fastening assembly 31 between several components 32, and the potting material 20 in the spaces 34 between them.

Both the components 32 and the connecting domes 1 are largely round in cross-section, so that larger and smaller spaces 34 are formed between the components 32 and the connecting domes 1, which are or will be filled with the potting material 20.

The connecting domes 1 form the fastening points for the cover 6.2 to the base 4.1. The cover 6.2 and the base 4.1 are then firmly connected to the screw elements 14 via the connecting domes 1, compensating for axial tolerances 22 (as previously described).

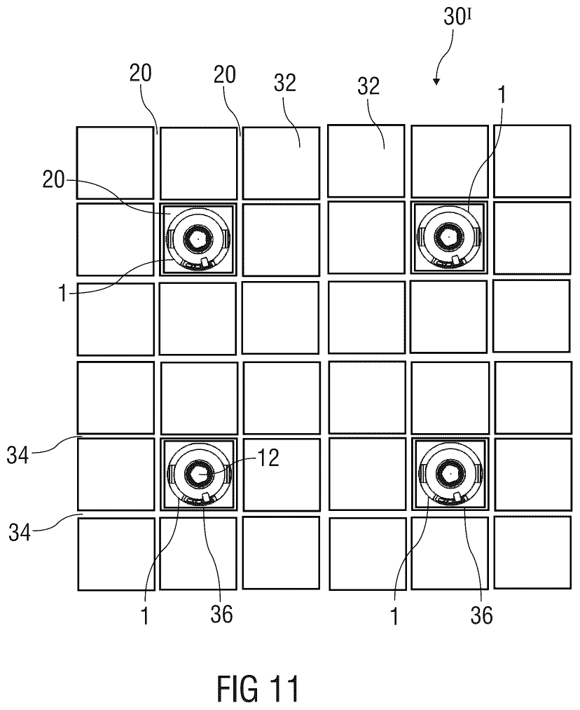

FIG. 11 shows a schematic side view of an alternative assembly 30^{I} without cover 6.2 and with several connecting domes 1 between several components 32 and the potting material 20 in the spaces 34 between them.

The respective connecting dome 1 is inserted into a partial housing. The assembly 30^{I} differs from the assembly 30 in the cross-sectional shape of the connecting domes 1 and the components 32.

Both the components 32 and the housings for the connecting domes 1 are rectangular, in particular square, in cross-section, so that equally sized spaces 34 are formed between the components 32 and the housings, which are or will be filled with the potting material 20. In addition, the inner cavity between the respective housing and the respective connecting dome 1 is filled with the potting material 20.

The connecting domes 1 form the fastening points for the cover 6.2 to the base 4.1. The cover 6.2 and the base 4.1 are then firmly connected to the screw elements 14 via the connecting domes 1, compensating for axial tolerances 22 (as previously described).

FIG. 12 shows a sectional view of an alternative connecting dome 1^{I} with the tolerance compensation unit 2. The alternative connecting dome 1^{I} comprises as a partial profile 18, in particular an external profile in sections, recesses 38, and/or webs 40. The recesses 38 may, for example, be introduced one above the other in at least one row from the outside into the connecting dome 1^{I}. Adjacent recesses 38 may be separated by a web 40. The recesses 38 each have a concave shape. Preferably, only one row of recesses 38 alternating with webs 40 is introduced from the outside of the connecting dome 1^{I}. Alternatively, a number of recesses 38 and/or webs 40 may be introduced into the connecting dome 1^{I} in a symmetrically distributed manner.

The alternative connecting dome 1^{I} has an anti-rotation contour 36 instead of the rib profile according to FIGS. 1 to 11. The anti-rotation contour 36 is formed by the radially inwardly introduced recesses 38 in the connecting dome 1^{I}. For example, several recesses 38 along the longitudinal axis 8 (shown in FIG. 1) may be introduced into an outer wall of the connecting dome 1^{I} one above the other and at a distance from each other. The recesses 38 are separated from each other by webs 40, which act as pull-out protection.

When connecting to the component 4 by means of the potting material 20, said potting material flows into the recesses 38 of the connecting dome 1^{I}. As a result, the connecting dome 1^{I} is form-fittingly and force-fittingly connected to the component 4 via the potting material 20.

In addition, the tolerance compensation unit 2 and the connecting dome 1^{I} may be coupled by means of a releasable transport lock 42.

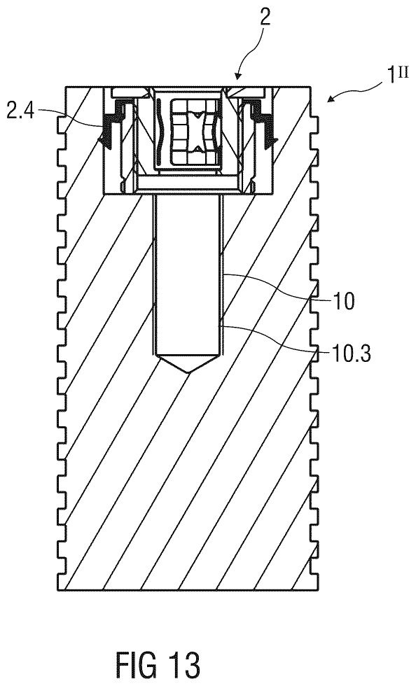

FIG. 13 shows a sectional view of another alternative connecting dome 1^{II} with the tolerance compensation unit 2. The alternative connecting dome 1^{II} differs from the previous connecting dome 1^{I} only in the type of bore 10. The bore 10 of the alternative connecting dome 1^{II} extends only over a given section in the connecting dome 1^{II} and not over its entire length, and is designed as a so-called blind hole. The bore 10 of the alternative connecting dome 1^{II} has an internal thread 10.3 in sections instead of the nut element 12. The tolerance compensation unit 2 is retained in the connecting dome 1^{II} by means of the retainer 2.4 (shown in FIG. 1).

FIG. 14 shows a sectional view of another alternative connecting dome 1^{III} with the tolerance compensation unit 2.

The alternative connecting dome 1^{III} differs from the previous connecting dome 1^{II} only in the type of bore 10. The tolerance compensation unit 2 is retained in the connecting dome 1^{III} by means of the internal thread 10.3 instead of the retainer 2.4 according to FIGS. 1 and 13.

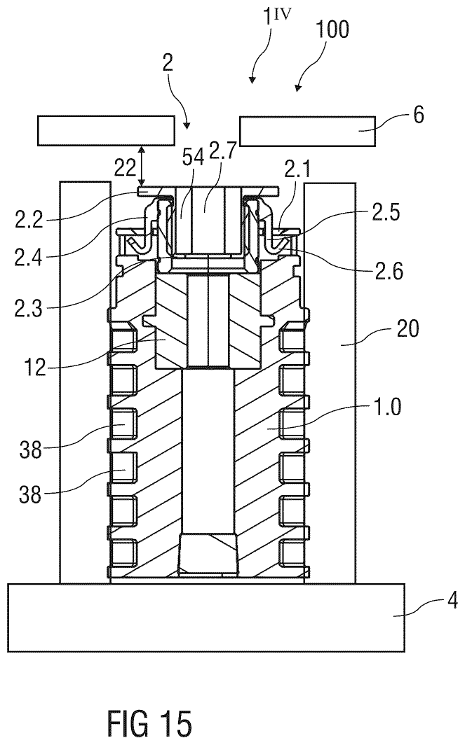

FIG. 15 shows a sectional view of another alternative connecting dome 1^{IV} with tolerance compensation unit 2 and nut element 12, integrated into the bore 10 of the dome element 1.0, in an initial state or in the initial position 100 before connection and before compensation for the axial tolerances 22 between compensating element 2.2 and component 6. The connecting dome 1^{IV} is, analogously to connecting dome 1^{I} according to FIG. 12, provided with recesses 38 for the introducing the potting material 20.

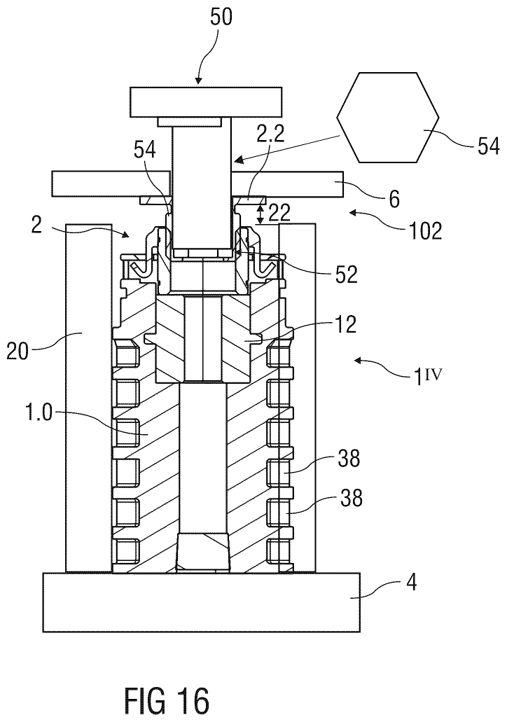

To compensate for the axial tolerances 22, a drive element 50, in particular a hexagon key, can be inserted into the through-opening 2.7, as shown in FIG. 16. The drive element 50 and the through-opening 2.7 have a drive interface 52 which is designed as a complementary cross-sectional area 54, in particular as a multi-edged, in particular hexagonal, cross-sectional area 54.

FIG. 16 shows the sectional view of the connecting dome 1^{IV} after axial tolerance compensation by means of the drive element 50. The compensating element 2.2 lies flat against the component 6.

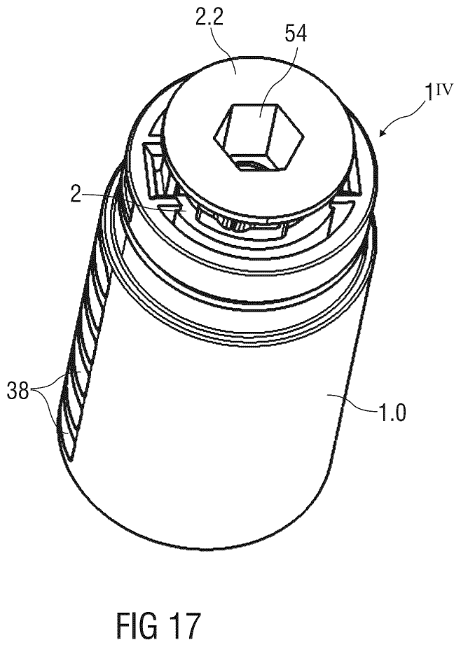

FIG. 17 shows a perspectival view of the connecting dome 1^{IV} with integrated tolerance compensation unit 2 with the compensating element 2.2 with the corresponding cross-sectional area 54 of the drive interface 52 for inserting the drive element 50 (shown in FIG. 16).

### LIST OF REFERENCE SIGNS

1, 1^{I}, 1^{II}, 1^{III}, 1^{IV} Connecting dome
1.0 Dome element
1.1 End face
2 Tolerance compensation unit
2.1 Base element
2.2 Compensating element
2.2.1 Contact flange
2.3 Entrainment element
2.4 Retainer
2.5 Holding arm
2.6 Latching hook
2.7 Through-opening
3 Threaded connection
3.1, 3.2 Thread
4 Component
4.1 Base
6 Component
6.1 Component opening
6.2 Cover
8 Longitudinal axis
10 Bore
10.1 Receiving section
10.2 Connecting section
10.3 Internal thread
12 Nut element
14 Screw element
16 Circumferential surface
16.1 Inner circumferential surface
16.2 Outer circumferential surface
18 Profile
18.1 Circumferential rib
18.2 Longitudinal rib
18.3 Radial rib
18.4 Internal profile
20 Potting material
22 Axial tolerances/axial tolerances
24 Locking element
30, 30^{I} Assembly
31 Mounting assembly
32 Components
34 Space
36 Anti-rotation contour
38 Recess
40 Web
42 Transport lock
50 Drive element
52 Drive interface
54 Cross-sectional area
100 Starting position
102 Compensating position

What is claimed is:

1. A connecting dome for fastening at least one component and/or for connecting two components, wherein the connecting dome is designed as an assembly unit and comprises a dome element with a longitudinal axis and a bore in which a tolerance compensation unit is arranged.

2. The connecting dome according to claim 1, wherein the dome element has such a shape in sections on an outer circumferential surface that it forms a form-fitting connection when encapsulated with a potting material.

3. The connecting dome according to claim 2, wherein the circumferential surface is in sections provided with a profile with recesses and/or webs.

4. The connecting dome according to claim 3, wherein the profile is designed as a rib profile, a force-fitting profile, a material-locking profile, and/or a form-fitting profile.

5. The connecting dome according to claim 1, wherein the dome element has an internal profile comprising a thread profile or a screw profile in sections on an inner circumferential surface.

6. The connecting dome according to claim 3, wherein the dome element has in sections on an outer circumferential surface such a profile that, when encapsulated with a potting material, it forms a material, form-fitting, and/or force-fitting connection.

7. The connecting dome according to claim 1, wherein the tolerance compensation unit comprises at least one compensating element and a base element, which are adjustably in threaded engagement with each other, and at least one retainer.

8. The connecting dome according to claim 7, wherein the tolerance compensation unit is retained in the bore by the retainer in a form-fitting and/or force-fitting manner.

9. The connecting dome according to claim 1, wherein the tolerance compensation unit is arranged in the bore in an initial state such that it terminates flush with the dome element.

10. The connecting dome according to claim 1, wherein the tolerance compensation unit is arranged in the bore such that at least a part of the tolerance compensation unit in a compensation state projects at least in sections beyond the bore.

11. The connecting dome according to claim 1, wherein the tolerance compensation unit has an entrainment element comprising a spring element, or a drive interface in or on the compensating element.

12. A fastening assembly for fastening the at least one component or for the connecting components to be connected to each other, wherein a plurality of connecting domes according claim 1 is provided and wherein the connecting domes are encapsulated or overmolded with a potting compound and are firmly connected to the component or one of the components, and the tolerance compensation unit in the fastened state to the component or in the connected state of the components compensates for any play with respect to the component or between the components.
